(19) United States
(12) Patent Application Publication
(10) Pub. No.: US 2008/0196455 A1
(43) Pub. Date: Aug. 21, 2008

(54) Lock with Rotor Fixing Element

(75) Inventor: Alain Desarmenien, Creteil Cedex (FR)

Correspondence Address: OSHA LIANG L.L.P., 1221 MCKINNEY STREET, SUITE 2800, HOUSTON, TX, 77010, US

(73) Assignee: VALEO SECURITE HABITACLE, Creteil Cedex (FR)

(21) Appl. No.: 11/913,897

(22) PCT Filed: Apr. 21, 2006
(86) PCT No.: PCT/EP06/61730

§ 371 Date: Nov. 8, 2007

(30) Foreign Application Priority Data
May 10, 2005 (FR) 05/04654

(51) Int. Cl. E05B 17/20

(52) U.S. Cl. 70/91

(57) ABSTRACT

A lock to be mounted on a door, including a rotor assembly and a stator assembly, where the rotor assembly is connected to a locking/unlocking actuator to allow locking and unlocking of the lock when an appropriate key is inserted into the lock, wherein the rotor assembly includes a means for retaining the rotor assembly, where the retaining means is fixed by clipping the retaining means onto the stator assembly, where the fixing part(s) of the retaining element are intended to be positioned between the stator and a handle of the door.

The invention relates to a conventional lock comprising an element for fixing/retaining the rotor such that any removal/forcing-in of the rotor is made impossible. This invention applies to all types of lock, in particular in the automotive or building field and is intended to make them tamper-proof.

A lock is composed of a fixed part, denoted the stator, and a mobile part, denoted the rotor, rotating in the fixed part. The rotor conventionally houses tumblers which make it possible to recognize a key authorized to lock/unlock the lock.

During an attempt to break into a lock, an individual attempts to remove the rotor which gives access to the head of the locking/unlocking actuator which makes it possible for him/her to force the lock rapidly.

To avoid the removal of the rotor, currently a plurality of systems are provided which may be possibly combined on the same lock:
an attached anti-pull-out plate: said plate is fixed to the stator by punching and requires a pin to be fixed effectively,
a bayonet fixing of the rotor in the stator: this consists of a small amount of the material of the rotor being fixed in the stator or the intermediate stator so as to fix said stator to the rotor,
a circlip on the end of the rotor: the circlip consists of a circular plastics material intended to grip and fix the head of the locking/unlocking actuator through the rotor,
a clipping ring providing the axial blocking of the rotor/stator: functions in a substantially identical manner to the circlip.

Unfortunately, these different solutions do not allow the pulling-out or forcing-in of the rotor to be resisted for any length of time. Moreover, with the conventional solution of anti-pull-out plates, it is relatively easy to remove said anti-pull-out plates before continuing to pull out or force in the rotor.

The present invention proposes a device which is simple and very easy to implement, providing increased tamper-proofness of the lock, i.e. preventing the rotor from being forced in or pulled out, said device no longer being accessible once it is fixed to the lock and said lock is fixed to the door. Moreover, the invention is much less costly than the current solutions.

The present invention relates to a lock to be mounted on a door, comprising a rotor assembly and a stator assembly, said rotor assembly being connected to a locking/unlocking actuator to allow locking/unlocking when an appropriate key is inserted into the lock, characterized in that it comprises a means for retaining the rotor assembly, said retaining means being fixed by being clipped onto the stator assembly.

The retaining means is fixed to the stator assembly after the rotor assembly and the stator assembly have been mounted and fixed to one another such that it is very easy to fix the retaining element and this fixing has no impact on the operations for mounting the lock.

The rotor assembly essentially comprises the rotor itself whilst the stator assembly comprises the stator and possibly an intermediate stator, in the case where the lock is a disengageable lock (the rotor is thus disengageable relative to the stator if an inappropriate key is introduced into the insertion channel of the lock and actuated) in addition to the conventional elements such as the disengagement spring, the indexer and the driving element. Generally, the present invention may be applied to all types of lock, whether they are disengageable or not, without modifications to the elements which make up the lock, with the exception of the production of housings or recesses intended to receive a portion of the retaining means.

Further particularities of the invention are presented below:
the retaining element comprises a plurality of lugs housed in recesses, or housings, of the stator.
the retaining element comprises three lugs, at least one thereof being provided at its end with a clipping means. In this case, ideally, each of the lugs of the retaining element comprises a clipping means.
the retaining element comprises a circular part intended to bear against the rotor assembly.
the retaining element is made of metal, for example steel.
the fixing part(s) of the retaining element is/are intended to be positioned between the stator and the handle of the door. The term “handle” denotes the position where the lock is fixed in the door and is made up of a housing of a size and shape adapted to that of the lock, said housing being defined by two conventionally cylindrical walls. The fixings of the retaining element, once fixed to the stator, prevent the removal of the rotor as the fixings are located between the stator and the wall(s) of the handle such that it is impossible to reach said fixings of the retaining element. Thus, once fixed to the stator assembly, the retaining element may no longer be removed, except of course by completely damaging the door.

The invention will be better understood by reading the following description and by viewing the accompanying figures, in which:

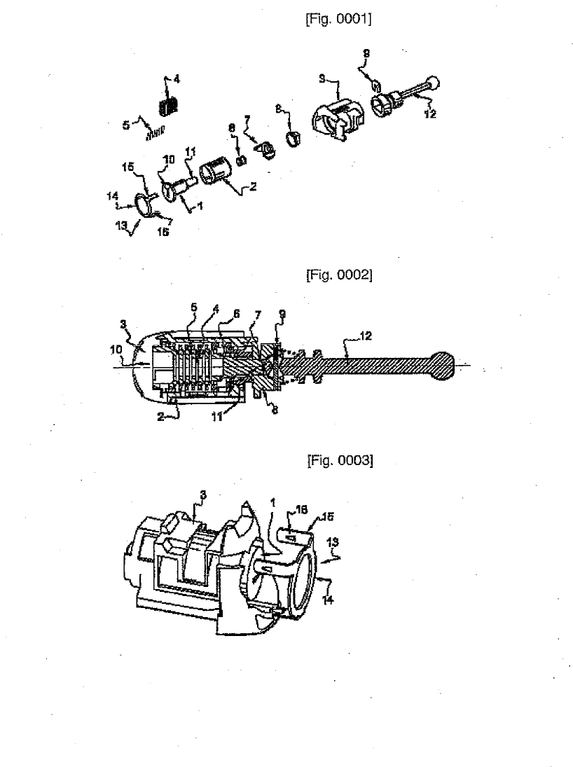

FIG. 1 shows an exploded view of a disengageable lock according to the invention,

FIG. 2 shows a sectional view of the lock of FIG. 1, once said lock is assembled,

FIG. 3 shows a view in perspective of a lock according to the invention with the retaining element of the rotor about to be fixed,

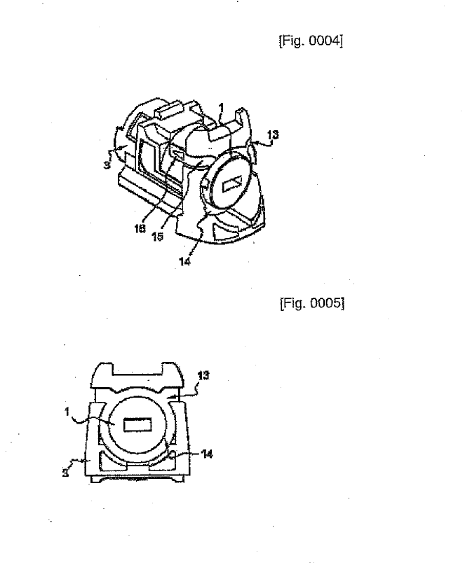

FIG. 4 shows a perspective view of the lock shown in FIG. 3, once the retaining element is mounted and fixed,

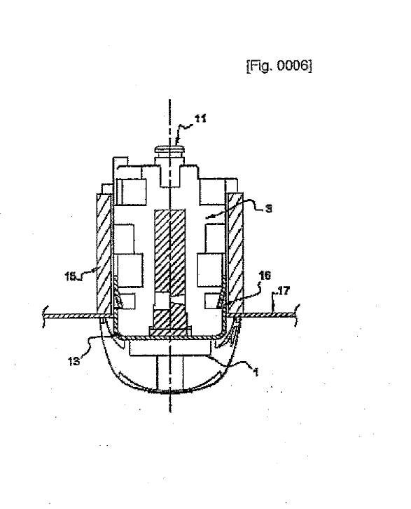

FIG. 5 shows a front view of the lock shown in FIG. 4,

FIG. 6 shows a sectional view of the lock shown in FIGS. 4 and 5.

In the example selected to illustrate the invention, the lock is disengageable, as is visible in particular in FIGS. 1 and 2.

Said lock comprises a rotor 1 which is rotatably mounted in an intermediate stator 2, said intermediate stator itself being pivotably mounted in the stator 3, or fixed body, of the lock. The lock also comprises the conventional essential elements such as the tumblers 4, the tumbler springs 5, the disengagement spring 6, the indexer 7, the driving element 8 and the circlip 9.

The rotor is intended to be driven in rotation using a key (not shown) inserted axially into the insertion channel 10 inside the rotor.

The front axial end of the rotor 11, i.e. the end opposing the entrance of the insertion channel of the key, is intended to cooperate with a cardan sub-assembly 12 to allow the locking and the unlocking of a door of the vehicle.

The conventional elements relating to the lock and to its method of assembly not forming part of the present invention will not be described in more detail.

The particularity of the invention is in the retaining element 13 of the rotor assembly.

As shown in FIGS. 1 and 3, the retaining element 13 has a stool-type shape comprising a circular part recessed at its center 14 and comprising a plurality of lugs 15, in this case three, of which at least one is provided at its end with a clipping means 16.

The retaining element is generally a part made of metal, in this case steel. It could be entirely made of hard plastics material or ceramics.

Reference is now made to FIGS. 3, 4 and 5.

Once the elements of the lock have been assembled, i.e. the rotor assembly 1, 4, 5, 10, 11 and the stator assembly 2, 3, 6, 7, 8 have been mounted and fixed to one another, the retaining element 13 is fixed by clipping into the recesses of the stator 3 by means of said lugs 15.

The fixing of the retaining element 13 on the stator assembly 3 is ensured by a clipping means 16, present at the end of at least one of the lugs 15 of the retaining element 13, and cooperating with a recess or a notch of the stator 3.

The clipping is carried out when the retaining element 13 abuts against the walls of the stator/rotor assembly; the circular part 14 of the retaining element 13 in turn bearing against the rotor 1, more specifically against the external face of the rotor 1.

By referring to FIG. 6, the lock assembly associated with the retaining element is conventionally fixed to the panel 17 of the door of the vehicle by being snapped into the handle 18, consisting of a housing, of a size and shape adapted to those of the lock, conventionally two cylindrical walls.

In this configuration, the retaining element 13 of which the fixing(s) 15, 16 are located between the stator 3, i.e. the external lateral faces of the stator 3 and the internal walls of the handle 18, may no longer be removed since said fixing(s) 15, 16 is(are) not accessible from the outside.

As a result, moreover, due to its retention by the retaining element 13, the rotor 1 may no longer be pulled out to allow an individual to access the head of the locking/unlocking actuator, unless of course by completely damaging the door.

1. A lock to be mounted on a door, comprising:
a rotor assembly and a stator assembly,
said rotor assembly being connected to a locking/unlocking actuator to allow locking and unlocking of the lock when an appropriate key is inserted into the lock, wherein the rotor assembly comprises a means for retaining the rotor assembly, said retaining means being fixed by being clipped onto the stator assembly, wherein the fixing part(s) of the retaining element are intended to be positioned between the stator and a handle of the door.

2. The lock as claimed in claim 1, wherein the retaining element comprises a plurality of lugs housed in recesses, or housings, of the stator.

3. The lock as claimed in claim 1, wherein the retaining element comprises three lugs, at least one thereof being provided at its end with a clipping means.

4. The lock as claimed in claim 1, wherein the retaining element comprises a circular part intended to bear against the rotor assembly.

5. The lock as claimed in claim 1, wherein the retaining element is made of metal, for example steel.

6. The lock as claimed in claim 3, wherein each of the lugs of the retaining element comprises a clipping means.
